(19) United States
(12) Patent Application Publication
(10) Pub. No.: US 2005/0172284 A1
(43) Pub. Date: Aug. 4, 2005

(54) Method and system for automated generation of customized factory installable software

(76) Inventors: Shree A. Dandekar, Round Rock, TX (US); Brian Bearden, Austin, TX (US); David A. Butts, Austin, TX (US)

Correspondence Address: HAMILTON & TERRILE, LLP, P.O. BOX 203518, AUSTIN, TX, 78720, US

(21) Appl. No.: 10/768,823

(22) Filed: Jan. 30, 2004

(51) Int. Cl. G06F 9/445

(52) U.S. Cl. 717/175; 717/169

(57) ABSTRACT

An automated system for software installation in a build-to-order information handling system. In one embodiment of the invention, a plurality of software applications are received and are disassembled to separate the individual constituent program files. These program files are decompressed and are stored in temporary file directories. Program files that are common to each of the software applications are identified and indexed. After the file analysis, the files are regrouped and a stored as a new set of compressed files. Once the new set of compressed files has been created, the top level scripts for the software application images are updated for use with the new compressed files to allow the desired combinations of software applications to be regenerated. The regenerated compressed files are then loaded into the factory servers for use in manufacturing information handling systems.

### BACKGROUND OF THE INVENTION

1. Field of the Invention

The present invention relates in general to the field of information handling systems and, more particularly, to a method and system for automatically generating customized factory installable software.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In recent years, there has been an increase in the number of information handling systems that are manufactured based on a “build to order” process that allows a customer to specify specific hardware and software options.

In “build to order” manufacturing systems, the operating system and other software files are stored as groups of compressed (“ZIP”) files that are organized according to software part numbers (“SRVs”). Each of the software part numbers is assigned a shell script (top script), and each of these scripts contains the names of corresponding ZIP files to download.

Vendors typically supply installable software packages in a format designed to run from a compact disc read-only memory (CD). It is necessary to “repack” the software to change the structure of this package to install the package correctly. Certain installations require customizations to meet manufacturability or marketing goals. These customizations require semi-custom code to implement on a per install basis.

Different operating systems, multiple language versions and their related service packs can complicate the process of creating “factory installable bits.” In addition, the larger files require more download time which results in longer “burn” time for each system in the manufacturing process. In prior build-to-order systems, engineers manually transformed the “zipped” files. This is a time consuming and error prone process. Customization codes for the installable software also was manually created by an engineer. This not only increases the probability of human-induced error, but dramatically increases the time required to deliver validated, installable software images to the factory environment.

In view of the foregoing, there is a need for an automated system for generating customized software for installation on a build-to-order information handling system. Such a system is provided by the present invention, as described hereinbelow.

### SUMMARY OF THE INVENTION

The present invention overcomes the shortcomings of the prior art by providing an automated system for software installation in a build-to-order information handling system. In an embodiment of the invention, a plurality of software applications are received and are disassembled to separate the individual constituent program files. These program files are decompressed and are stored in temporary file directories. Program files that are common to each of the software applications are identified and indexed. After the file analysis, the files are regrouped and a stored as a new set of compressed (ZIP) files. Once the new set of ZIP files has been created, the top level scripts for the software application images are updated for use with the new ZIP files to allow the desired combinations of software applications to be regenerated. The new ZIP files are then loaded into the factory servers for use in manufacturing information handling systems.

In the present invention, an automated tool receives the files and related data from a database. This tool automatically collects the information that is needed to create the new factory installable package. The steps implement by the system include: 1) changing the path information for each file in the install package; 2) splitting large files into multiple smaller files; and 3) deleting files that will not be needed from the zip files.

The automated system of the present invention is also operable to interact with a database to create customizations for various software installations (e.g., screen resolution). This tool automatically collects the information needed to create customization code and integrate the code in the scripts. The steps implemented by the system include: 1) generating customization parameters and placing these parameters in a database; 2) using the customization tool to collect the information from the database and create the appropriate customization code; and 3) integrating into the script during automate script generation.

The method and apparatus of the present invention overcomes the shortcomings of the prior art by removing all human interaction from the build process once the third party software has been delivered. It further reduces human error and the time that would be necessary to correct such errors and, also reduces the time required to configure and execute the software installation. Moreover, it reduces the inherent lag time between individual steps and the workflow of the build-to-order system.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a general illustration of an automated build-to-order system for installing software on an information handling system.

FIG. 2 is a system block diagram of an information handling system.

FIG. 3 is an illustration of an embodiment of an automated system for validating, transforming and integrating software for installation on an information handling system.

FIG. 4 is a flowchart illustration of the processing steps for automatically generating factory installable software in accordance with the present invention.

### DETAILED DESCRIPTION

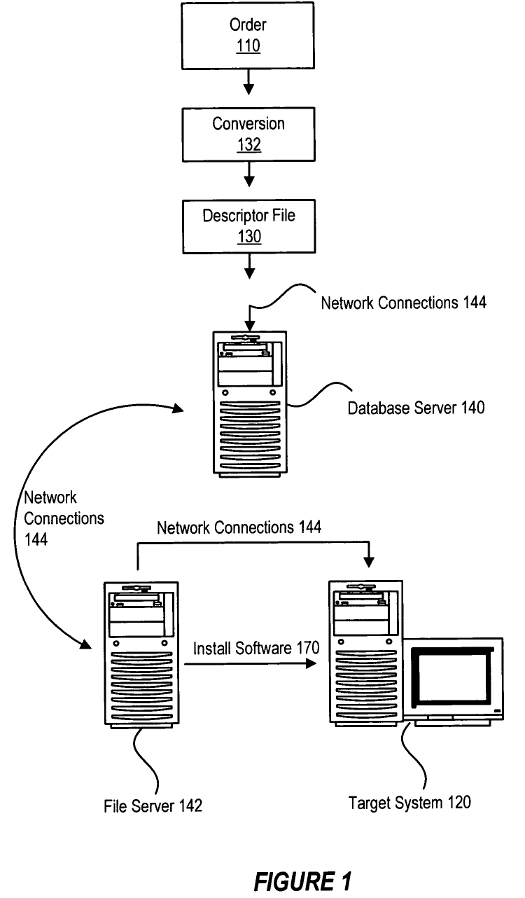

FIG. 1 is a schematic diagram of a software installation system 100 at an information handling system manufacturing site. In operation, an order 110 is placed to purchase a target information handling system 120. The target information handling system 120 to be manufactured contains a plurality of hardware and software components. For instance, target information handling system 120 might include a certain brand of hard drive, a particular type of monitor, a certain brand of processor, and software. The software may include a particular version of an operating system along with all appropriate driver software and other application software along with appropriate software bug fixes. Before target information handling system 120 is shipped to the customer, the plurality of components are installed and tested. Such software installation and testing advantageously ensures a reliable, working information handling system which is ready to operate when received by a customer.

Because different families of information handling systems and different individual computer components require different software installation, it is necessary to determine which software to install on a target information handling system 120. A descriptor file 130 is provided by converting an order 110, which corresponds to a desired information handling system having desired components, into a computer readable format via conversion module 132.

Component descriptors are computer readable descriptions of the components of target information handling system 120 which components are defined by the order 110. In a preferred embodiment, the component descriptors are included in a descriptor file called a system descriptor record which is a computer readable file containing a listing of the components, both hardware and software, to be installed onto target information handling system 120. Having read the plurality of component descriptors, database server 140 provides a plurality of software components corresponding to the component descriptors to file server 142 over network connection 144. Network connections 144 may be any network connection well-known in the art, such as a local area network, an intranet, or the internet. The information contained in database server 140 is often updated such that the database contains a new factory build environment. The software is then installed on the target information handling system 120. The software installation is controlled by a software installation management server, discussed in greater detail below, that is operable to control the installation of the operating system and other software packages specified by a customer.

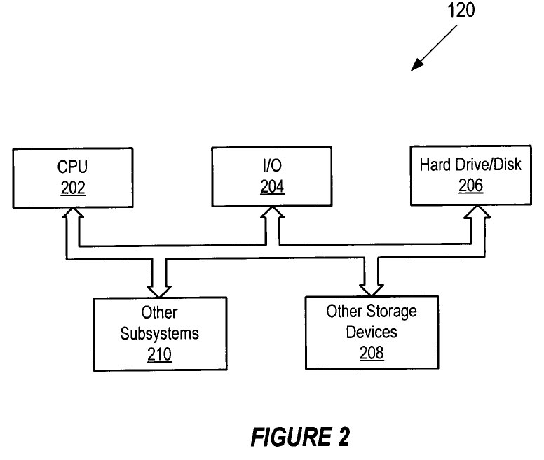

FIG. 2 is a generalized illustration of an information handling system, such as the target information handling system 120 illustrated in FIG. 1. The information handling system includes a processor 202, input/output (I/O) devices 204, such as a display, a keyboard, a mouse, and associated controllers, a hard disk drive 206, and other storage devices 208, such as a floppy disk and drive and other memory devices, and various other subsystems 210, all interconnected via one or more buses 212. The software that is installed according to the versioning methodology is installed onto hard disk drive 206. Alternately, the software may be installed onto any appropriate non-volatile memory. The non-volatile memory may also store the information relating to which factory build environment was used to install the software. Accessing this information enables a user to have additional systems corresponding to a particular factory build environment to be built.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

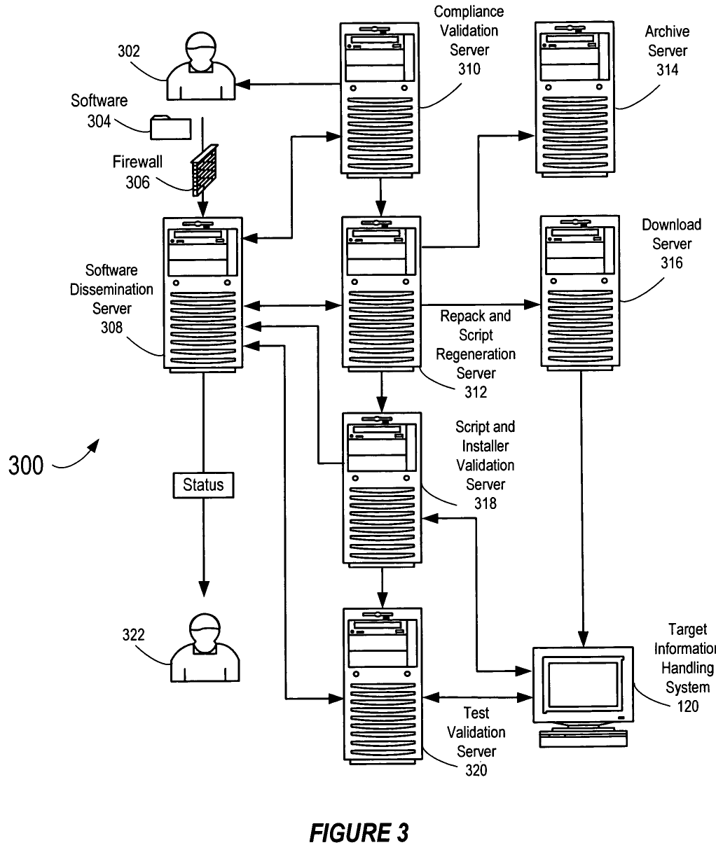

FIG. 3 is an illustration of the components of the automated system for converting, optimizing and disseminating software in accordance with the present invention. A third party 302 delivers a software package 304 to the system via a firewall 306. If the software package 304 is verified and authorized to pass through the firewall, it is received by a software dissemination server 308. The software package is associated with a software part number (SRV) that specifies various parameters related to the installation and operation of the software on an information handling system. Examples of parameters include: compatible operating systems (OSes), enabled languages (e.g., English, Chinese, etc), installation command lines, a “prune” list of files that can be removed for certain installations and silent install switches.

The software dissemination server 308 scans the software package for viruses and transfers the file to a compliance validation server 310 which verifies that the software package complies with a predetermined set of rules required by the build-to-order automated manufacturing system. Examples of such rules include, but are not limited to, naming conventions, length of directory path names, “hidden only” attributes, and “read only” attributes. If the compliance validation server 310 determines that the software package 304 contains errors or that it fails to comply with the predetermined rules, an e-mail notice is sent to the third party 302 to notify the third party about the specific errors and non-compliance parameters that were detected. If, however, the compliance validation server 310 determines that the software package is in compliance, then a compliance validation notice is sent to the repack and script regeneration server 312 which then downloads the software package from the software dissemination server 308.

The repack and script regeneration server 312 disassembles and the software package 304 into individual constituent program files and decompresses these individual files. The decompressed individual program files are stored in temporary file directories on the repack and script regeneration server 312 and an index of the files is created. The repack and script regeneration server 312 uses the index to purge individual files that are on a “prune list” associated with the software package. The server 312 then regroups and compresses (ZIPs) the files to generate repackaged software for use in the build-to-order factory system. In this process, the server 312 generates factory scripts for each package to produce “factory installable bits.” These “factory installable bits” are then transferred to the download server 316. A copy of the software package 304 is also transferred to an archive server 314. The repack and script regeneration server 312 then generates a signal authorizing the script and installation validation server 318 to generate appropriate commands to control downloading of software by the target information handling system 120. The results of the installation are monitored by the server 318 and results are communicated to the software dissemination server 308 while the actual software images are downloaded by the download server 316 onto the hard drive or other storage media of the target information handling system 120.

After the software images have been downloaded to the target information handling system 120, tests are performed by a test validation server 320 which performs a series of tests to confirm that the software images have been properly installed and that the operational integrity of the software package is satisfactory. The results of the test performed by the test validation server 320 are communicated to the software dissemination server 308 which is operable to generate a status report for viewing by a program manager 322.

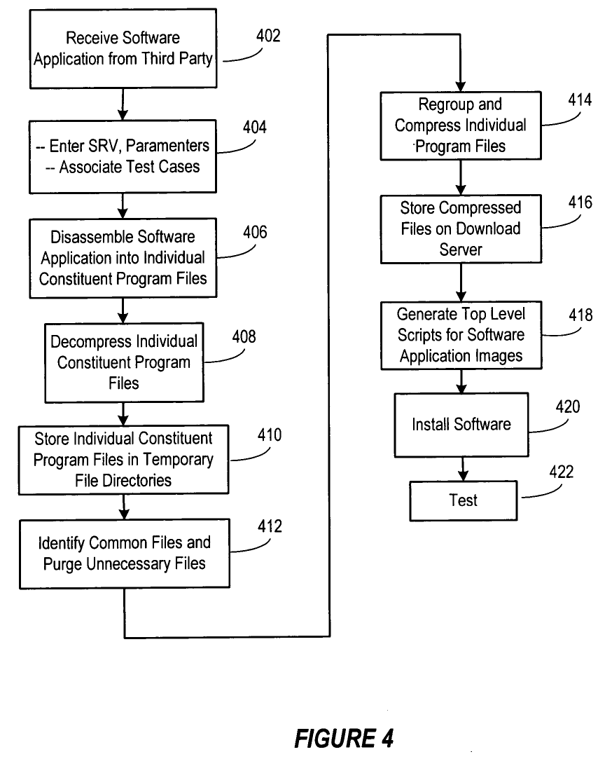

FIG. 4 is a flowchart illustration of the processing steps implemented by the system of the present invention. In step 402, a software application is received from a third party. In step 404, the software part number (SRV) associated with the software application is entered along with various parameters related to the installation and operation of the software on an information handling system. Examples of parameters include: operating systems (OSes), language (e.g., English, Chinese, etc), installation command lines, a “prune” list and silent install switches. In step 406, the software package is disassembled into individual constituent program files. These individual constituent program files are decompressed in step 408 and are then stored in temporary file directories in step 410. In step 412, common files are identified and unnecessary files are purged in accordance with the “prune list.” The remaining individual program files are regrouped and compressed into “ZIP” files in step 414 and are then stored on the download server in step 416.

In step 418, the top level scripts are generated for use with the new ZIP files to allow the desired combinations of software applications to be regenerated. In step 420, the top level scripts and the compressed software files are installed on a target information handling system 120. The information handling system 120 is then tested in step 422.

The automated system of can use a plurality of parameters stored in a database on the repack and script regeneration server 312 to create customizations for various software installations. For example, appropriate scripts can be generated to install a particular software package for operation at a predetermined screen resolution, based on a specified build-to-order parameter.

The method and apparatus of the present invention overcomes the shortcomings of the prior art by removing all human interaction from the build process once the third party software has been delivered. It further reduces human error and the time that would be necessary to correct such errors and, also reduces the time required to configure and execute the software installation. Moreover, it reduces the inherent lag time between individual steps and the workflow of the build-to-order system.

Testing of the software can be accomplished using the system and methods described in co-pending applications Ser. No. 10/267,513, filed on Oct. 9, 2002, entitled “Method and System for Test Management;” Ser. No. 09/564,054, filed on May 3, 2000, entitled “Automated Test System in a Factory Install Environment;” Ser. No. 10/614,762, filed on Jul. 7, 2003, entitled “Method and System for Information Handling System Automated and Distributed Test;” and Ser. No. 10/730,435, entitled “Improved Cache System in Factory Server for Software Dissemination,” filed on Dec. 8, 2003. Each of the aforementioned patent applications is hereby incorporated by reference herein for all purposes.

### OTHER EMBODIMENTS

Other embodiments are within the following claims.

For example, the above-discussed embodiments include software modules that perform certain tasks. The software modules discussed may include script, batch, or other executable files. The software modules may be stored on a machine-readable or computer-readable storage medium such as a disk drive. Storage devices used for storing software modules may be magnetic floppy disks, hard disks, or optical discs such as CD-ROMs or CD-Rs, for example. A storage device used for storing firmware or hardware modules may also include a semiconductor-based memory, which may be permanently, removably or remotely coupled to a microprocessor memory system. Thus, the modules may be stored within a computer system memory to configure the computer system to perform the functions of the module. Other new and various types of computer-readable storage media may be used to store the modules discussed herein. Consequently, the invention is intended to be limited only by the spirit and scope of the appended claims, giving full cognizance to equivalents in all respects.

Although the present invention has been described in detail, it should be understood that various changes, substitutions and alterations can be made hereto without departing from the spirit and scope of the invention as defined by the appended claims.

1. A system for automated dissemination of software to an information handling system, comprising:
a distribution server operable to receive a software file comprising a plurality of individual constituent program files and a plurality of installation parameters associated with said software file;
a repack and script regeneration server operably connected to said distribution server, wherein said repack and script server: a) disassembles said software file into a first plurality of individual constituent program files; b) generates customized installation scripts in accordance with said plurality of parameters associated with said software file; c) removes predetermined individual constituent program files from said plurality of individual constituent program files in accordance with a prune list, thereby creating a second plurality of individual constituent program files; and d) repackages said second plurality of files combined with said customized installation scripts to provide automatic transfer of said software files to an information handling system; and
a download server operable to transfer said second plurality of files to a target information handling system.

2. The system of claim 1, wherein one of said plurality of parameters associated with said software file comprises silent installation switches.

3. The system of claim 1, wherein one of said plurality of parameters associated with said software file comprises predetermined operating systems for operation with said software file.

4. The system of claim 1, further comprising a script validation server operably coupled to said repack and script regeneration server and said distribution server, said script validation server operable to generate commands to automatically control the downloading of software images of said software file to a target information handling system.

5. The system of claim 1 further comprising a compliance server operable to automatically generate a non-compliance notice message upon detection that said software files does not comply with said predetermined set of parameters.

6. The system of claim 1, further comprising a test control server operable to confirm the download of said software file to said target information handling system and to verify proper operation of said software file on said target information handling system.

7. The system of claim 1 wherein said distribution server is operable to notify a manager regarding the status of the software file within the software distribution system.

8. The system of claim 1 further comprising an archive server, wherein said repack and script regeneration server is operable to transfer copies of said repackaged software file to said archive server for storage thereon.

9. A method for automated dissemination of software to an information handling system, comprising:
receiving a software file comprising a plurality of individual constituent program files and a plurality of installation parameters associated with said software file;
disassembling said software file into a first plurality of individual constituent program files;
generating customized installation scripts in accordance with said parameters associate with said software file;
removing predetermined individual constituent program files from said plurality of individual constituent program files in accordance with a prune list, thereby creating a second plurality of individual constituent program files;
repackaging said second plurality of files combined with said customized installation scripts to provide automatic transfer of said software files to an information handling system; and
transferring said second plurality of files to a target information handling system.

10. The system of claim 9, wherein one of said plurality of parameters associated with said software file comprises silent installation switches.

11. The system of claim 10, wherein one of said plurality of parameters associated with said software file comprises predetermined operating systems for operation with said software file.

12. The method of claim 11, further comprising a script validation server operably coupled to said repack and script regeneration server and said distribution server, said script validation server operable to generate commands to automatically control the downloading of software images of said software file to a target information handling system.

13. The method of claim 11 further comprising a compliance server operable to automatically generate a non-compliance notice message upon detection that said software files does not comply with said predetermined set of parameters.

14. The method of claim 11, further comprising a test control server operable to confirm the download of said software file to said target information handling system and to verify proper operation of said software file on said target information handling system.

15. The method of claim 11 wherein said distribution server is operable to notify a manager regarding the status of the software file within the software distribution system.

16. The method of claim 11 further comprising an archive server, wherein said repack and script regeneration server is operable to transfer copies of said repackaged software file to said archive server for storage thereon.

17. An information handling system, comprising:
a data processor;
data storage having a software file stored thereon, wherein said software is transferred to said data storage by an automated software dissemination system comprising;
a distribution server operable to receive a software file comprising a plurality of individual constituent program files and a plurality of installation parameters associated with said software file;
a repack and script regeneration server operably connected to said distribution server, wherein said repack and script server: a) disassembles said software file into a first plurality of individual constituent program files; b) generates customized installation scripts in accordance with said plurality of parameters associated with said software file; c) removes predetermined individual constituent program files from said plurality of individual constituent program files in accordance with a prune list, thereby creating a second plurality of individual constituent program files; and d) repackages said second plurality of files combined with said customized installation scripts to provide automatic transfer of said software files to an information handling system; and
a download server operable to transfer said second plurality of files to a target information handling system.

18. The system of claim 17, wherein one of said plurality of parameters associated with said software file comprises silent installation switches.

19. The system of claim 17, wherein one of said plurality of parameters associated with said software file comprises predetermined operating systems for operation with said software file.

20. The system of claim 17, further comprising a script validation server operably coupled to said repack and script regeneration server and said distribution server, said script validation server operable to generate commands to automatically control the downloading of software images of said software file to a target information handling system.

21. The system of claim 17, further comprising a compliance server operable to automatically generate a non-compliance notice message upon detection that said software files does not comply with said predetermined set of parameters.

22. The system of claim 17, further comprising a test control server operable to confirm the download of said software file to said target information handling system and to verify proper operation of said software file on said target information handling system.

23. The system of claim 17, wherein said distribution server is operable to notify a manager regarding the status of the software file within the software distribution system.

24. The system of claim 17, further comprising an archive server, wherein said repack and script regeneration server is operable to transfer copies of said repackaged software file to said archive server for storage thereon.
